(19) United States
(12) Patent Application Publication
(10) Pub. No.: US 2016/0018005 A1
(43) Pub. Date: Jan. 21, 2016

(54) REPLACEABLE GLAND INSERT FOR INCREASED LIFE

(71) Applicants: Andrew Parkin, Rotherham (GB); Richard Abrahams, Rotherham (GB)

(72) Inventors: Andrew Parkin, Rotherham (GB); Richard Abrahams, Rotherham (GB)

(73) Assignee: AES Engineering Ltd., Rotherham (GB)

(21) Appl. No.: 14/805,169

(22) Filed: Jul. 21, 2015

(30) Foreign Application Priority Data
Jul. 21, 2014 (GB) 1412893.8

(51) Int. Cl. F16J 15/34

(52) U.S. Cl. CPC F16J 15/3464

(57) ABSTRACT

A mechanical seal component of a mechanical seal is substantially annular and includes a plurality of axially adjacent retaining recesses along its surface with each recess being adapted to accept a sealing member.

### BACKGROUND OF THE INVENTION

1. Technical Field of the Invention

The present invention relates, generally, to the use of mechanical seals and, more particularly, the use of mechanical seals in aggressive applications and, specifically, to a part insert that improves the useful life of expensive components.

2. Description of the Prior Art

A mechanical seal can be most simply characterized as an assembly containing one or more rotary faces and an equal number of opposing stationary faces, wherein the rotational and stationary faces are energized together to form a sealing surface. In addition to the rotary and stationary faces, there are additional sealing members, usually 0-Rings, which seal between relatively static components.

Mechanical seals are typically used on rotating equipment, most commonly pumps, and create a seal between the pump housing and the drive shaft. One category of seals are called cartridge seals, named so because the rotary and stationary components are held in a unitized assembly and designed to be fitted easily to the equipment in question.

In a cartridge seal, the stationary faces are fixedly held relative to the seal housing, or gland, and sealed such that no fluid may pass between the stationary faces and the gland. Additionally, the rotary faces are fixedly held relative to a shaft sleeve and sealed such that fluid may pass between the rotary faces and the shaft sleeve. Included in the shaft sleeve is a further sealing method to ensure that no fluid may pass along the shaft and escape the intended confines of the pump casing.

Due to the vast number of industries pumps are designed for, it follows that mechani-cal seal design has equally evolved to suit various different applications. In such applications where there is aggressive product being processed, it is not uncommon for seals to wear significantly faster than their counterparts installed on less aggressive applications. Seal companies have traditionally circumnavigated this problem by overdesigning the seals to enable them to absorb more damage or to use expensive exotic materials which are harder wearing. Both of these methods increase the cost of the mechanical seal.

Despite the addition of overdesigned components and exotic materials, it is still common for seals to wear away to the point that they can no longer perform. In these cases it is known to use a repair kit to replace the worn parts with new ones and keep all the compo-nents that are still in good working condition. Typically, however, these sorts of repairs can be quite costly, as it is not possible to completely prevent wear occurring and invariably, expensive components get damaged. Therefore, although some components can be reused, larger components which are exposed to the product, such as the gland, still have to be replaced as it is impossible to suitably protect them.

### SUMMARY OF THE INVENTION

According to the present invention there is provided a mechanical seal component, wherein the component is substantially annular and comprises a plurality of axially adjacent retaining recesses along a surface of the component, each adapted to accept a sealing member, wherein the sealing member is preferably toroidal.

The component provides a plurality of positions for the acceptance of an O-ring, each of which will form an acceptable sealing arrangement in the mechanical seal. During operation of the seal in an aggressive environment, the first sealing recess may become worn or damaged and the seal therein may become less efficient, which can lead to leakage and damage within the seal. Therefore, the part may be removed from the mechanical seal and a new seal formed in an adjacent retaining recess by positioning an O-ring in the unworn recess and reinstalling the part back into the seal. This allows for the part to be used for a longer period of time by moving the position of the active seal along the part via the plurality of adjacent recesses. The plurality of retaining recesses, which retain the active O-ring sealing member, that is, the O-ring forming the seal, provides back-up positions to allow extend the working life of the component by axially adjusting the position of the seal along the part.

The aggressive environment may be a chemically- or pH-aggressive environment or one where the seal component is exposed to a high level of wear.

Preferably, the retaining recesses are located such that the toroidal sealing member may occupy any or all of the retaining features, and maintain the integrity of the sealing path between the shaft and the housing, when in use. Ideally, a single O-ring would be provided in one of the grooves to seal between the annular component and seal housing. In the case that wear is experienced on the seal housing, the position of the O-ring would be changed to a groove and corresponding surface which has not worn.

Advantageously, the retaining recesses are located linearly along a surface of the component. Arranging the retaining recesses linearly ensures that a standard sealing member, usually in the form of an O-ring, can be used in each of the retaining recesses as and when required. While the recesses could be arranged in a non-linear fashion, for example, by using different sized O-rings in each retaining recess, where a linear arrangement is used, identical O-rings can be used in each retaining recess.

It is preferable that the component may be readily installed and uninstalled. This allows for easy maintenance of the part and the seal overall, including quick and easy refurbishment of the part. In such a preferred embodiment, the component may be connected by a bolt or a plurality of bolts or may be a snap-fit connection, which allows the part to be readily removed and the location of the active seal adjusted either by moving the existing O-ring to an adjacent retaining recess or by installing a new O-ring accordingly. This all reduces the downtime of the machine. It is known that seals in arduous applications experience high amounts of wear and it is the purpose of this invention to provide such components that may be replaced at minimal cost as well as extend the working life of an expensive component which would otherwise have been considered damaged.

It is advantageous that the component comprises at least one material selected from a group comprising: elastomer; ceramic; and metal. Hard-wearing materials are advantageous where they can be used to resist wear. The component may comprise a composite of materials, for example a metal part coated in a ceramic or elastomeric material. Where a material choice is considered to be advantageous to the application, the cost and durability may be important factors. The chosen materials may be a form of high duty elastomer or a performance ceramic, which is potentially inexpensive to replace or hard-wearing to increase performance.

In one preferred embodiment, the component is a gland or an end cap. These parts are particularly prone to wear and the present invention is especially useful in such components. Preferably, one or all of the components containing the O-ring groove is made of a metallic material. It is preferable that the component is made of a metal for the purpose of manu-facturing ease. In such cases, it may be advantageous to use an exotic alloy with beneficial properties.

In a preferred embodiment, the component comprises a plurality of axially adjacent retaining recesses on both its internal and external surfaces. Where the part is used to create more than one sealing arrangement, it may be provided with retaining recesses on both its inner and outer surface.

The present invention extends to a mechanical seal comprising at least one component. As such, the invention may comprise a mechanical sealing device for sealing a piece of rotating machinery, comprising of one or more rotary faces and one or more corresponding stationary faces, both containing a primary sealing surface and a secondary sealing surface and situated so that the primary sealing surface of the rotary face is in contact with the primary sealing surface of the corresponding stationary face, and wherein the faces are disposed such that both the rotary and stationary faces are sealed indirectly to the shaft and seal housing respectively via their secondary sealing surfaces and one or more toroidal sealing members, or O-rings, and where is included in the assembly one or more annular components disposed upon the sealing path between the shaft and the seal housing wherein is included one or more retaining features, or O-ring grooves (or “retaining recess”), adjacent to the sealing path, for the location of O-rings.

Preferably, the O-ring grooves are located such that the position of the O-ring may, in some instances, mean that the other grooves are located such that they are not in direct contact with the sealed product. With reference to the previous statement, the grooves would be located such that they do not experience wear until they housing an O ring for the purposes of sealing.

Preferably, one or all of the components are mounted within the assembly via the means of a resilient fitment through the compression of an O-ring. Additionally, there may be such means of fitment, such as, for example, shrink fit or bolted fitment.

While it is envisaged that the component would be fitted with a single O-ring in a single recess, there may be circumstances in which it could be advantageous to install O-rings in two or more of the plurality of retaining recesses as a failsafe should the first retaining recess fail.

The present invention also provides a method of prolonging the working lifetime of a substantially annular mechanical seal component, the method comprising the steps of providing the component with a plurality of axially adjacent retaining recesses along a surface of the component; providing a sealing member within one of the recesses, utilizing the mechanical seal until said one of the recesses is damaged; removing the sealing member from said recess; and fitting another sealing member to another of the recesses.

Other objects and features of the present invention will become apparent when considered in combination with the accompanying drawing FIGURE, which illustrates a certain preferred embodiment of the present invention. It should, however, be noted that the accompanying drawing FIGURE is intended to illustrate only select preferred embodiment of the claimed invention and is not intended as a means for defining the limits and scope of the invention.

### BRIEF DESCRIPTION OF THE DRAWING FIGURE

The accompanying drawing is as follows:

FIG. 1 is a cross-sectional view of a preferred embodiment of a mechanical seal, in accordance with the present invention.

### DETAILED DESCRIPTION OF THE DRAWING FIGURES AND PREFERRED EMBODIMENTS

The invention will now be described, by way of an example, with reference to the accompanying drawing:

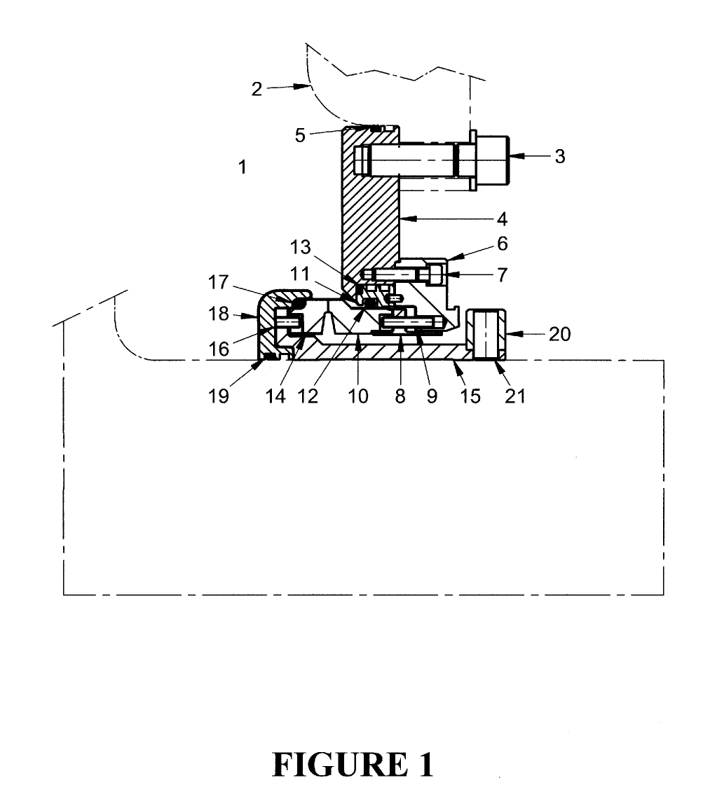

In FIG. 1, there is a shown a cross-sectional drawing of a mechanical seal 1, which is fitted to a pump housing 2, by means of a set of fixing bolts 3, which hold the gland housing 4 in place and, furthermore, where the gland housing is sealed to said pump housing 2 via elastomer 5. Included in the assembly and concentrically mounted to the gland housing 4 is a seal gland 6, which is fixed to the gland housing 4 via further fixing bolts 7 and wherein is located a spring plate 8 containing a drive pin 9 protruding into both the seal gland 6 and the rear of the stationary face 10, such that the stationary face 10 is held axially stationary to the pump housing 2, and where an annular component 11 is provided with a number of annular recesses such that the stationary sealing elastomer 12 and the gland housing sealing elastomer 13 may be located. Mounted adjacent and in contact with the stationary face 10 is the rotary face 14, which is coupled to the shaft sleeve 15 via a secondary drive pin 16 and which further seals via sealing elastomer 17 to the shaft sleeve end cap 18. Shaft sleeve end cap 18 is fixedly coupled to the shaft sleeve 15 and contains a plurality of recesses for the location of a shaft sealing elastomer 19. All components are held substantially concentric to the shaft sleeve 15, which is further coupled to the shaft via clamp ring 20 and grub screw 21.

While only several embodiments of the present invention have been shown and described, it will be obvious to those skilled in the art that many modifications may be made to the present invention without departing from the spirit and scope thereof.

What is claimed is:

1. A mechanical seal component, comprising:
a surface having a plurality of axially adjacent retaining recesses along said surface, each retaining recess of said plurality of axially adjacent retaining recesses being capable of accepting a sealing member, said mechanical seal component being substantially annular.

2. The mechanical seal component according to claim 1, wherein said plurality of axially adjacent retaining recesses are located for permitting the sealing member to occupy at least a portion of said retaining recesses for retaining the sealing member and for maintaining a sealing path during usage.

3. The mechanical seal component according to claim 1, wherein said plurality of axially adjacent retaining recesses is located linearly along said surface of said mechanical seal component.

4. The mechanical seal component according claim 1, wherein said surface of said mechanical seal component is made of at least one of an elastomer, a ceramic and a metal.

5. The mechanical seal component according to claim 1, wherein said mechanical seal component is a gland.

6. The mechanical seal component according to claim 1, wherein said mechanical seal component is an end cap.

7. The mechanical seal component according to claim 1, wherein said surface includes an internal surface and an external surface with said plurality of axially retaining recesses being present on both said internal surface and said external surface.

8. A mechanical seal, comprising:
a mechanical seal component being substantially annular and having a surface with a plurality of axially adjacent retaining recesses along said surface, each retaining recess of said plurality of axially adjacent retaining recesses being capable of accepting a sealing member.

9. The mechanical seal according to claim 8, wherein said plurality of axially adjacent retaining recesses of said mechanical seal component are located for permitting the sealing member to occupy at least a portion of said retaining recesses for retaining the sealing member and for maintaining a sealing path during usage.

10. The mechanical seal according to claim 8, wherein said plurality of axially adjacent retaining recesses is located linearly along said surface of said mechanical seal component.

11. The mechanical seal according claim 8, wherein said surface of said mechanical seal component is made of at least one of an elastomer, a ceramic and a metal.

12. The mechanical seal according to claim 8, wherein said mechanical seal component is a gland.

13. The mechanical seal according to claim 8, wherein said mechanical seal component is an end cap.

14. The mechanical seal according to claim 8, wherein said surface of said mechanical seal component includes an internal surface and an external surface with said plurality of axially retaining recesses being present on both said internal surface and said external surface of said mechanical seal component.

15. A method for prolonging working lifetime of a substantially annular mechanical seal component of a mechanical seal, comprising the steps of:
providing a substantially annular mechanical seal component with a plurality of axially adjacent retaining recesses along a surface of the substantially annular mechanical seal component;
fitting a first sealing member within at least one recess of said plurality of axially adjacent retaining recesses of the substantially annular mechanical seal component;
utilizing a mechanical seal until at least one recess of said plurality of axially adjacent retaining recesses of the substantially annular mechanical seal component is damaged preventing proper usage;
removing the first sealing member from said at least one recess of said plurality of axially adjacent retaining recesses of the substantially annular mechanical seal component; and,
fitting a second sealing member within at least one recess of said plurality of axially adjacent retaining recesses of the substantially annular mechanical seal component, the second sealing member being fitted into a different retaining recess than said at least one recess wherein said first sealing member was fitted.
